(19) United States
(12) Patent Application Publication
(10) Pub. No.: US 2015/0251080 A1
(43) Pub. Date: Sep. 10, 2015

(54) Educational Life Skills Board Game and Electronic Version Thereof

(71) Applicant: Debra P. Avara, Amarillo, TX (US)

(72) Inventor: Debra P. Avara, Amarillo, TX (US)

(21) Appl. No.: 14/642,744

(22) Filed: Mar. 9, 2015

Related U.S. Application Data
(60) Provisional application No. 61/950,100, filed on Mar. 8, 2014.

(51) Int. Cl. A63F 3/00; A63F 13/822; A63F 11/00

(52) U.S. Cl. CPC A63F 3/00072; A63F 11/0011; A63F 13/822; A63F 2003/00066

(57) ABSTRACT

A learning game played by a one or more players comprising a game board, a one or more avatars, a random number generators, a currency, an items table having a plurality of items. Each of said plurality of items having a description, a one or more prices, and a need or want flag. Said need or want flag of said plurality of items comprise a categorization into a needs category and a wants category. Said game board having a plurality of spaces. Said plurality of spaces comprising at least a one or more payment spaces, a one or more bad event spaces, and a one or more savings spaces. Said one or more players are each assigned one among said one or more avatars, a copy of said items table.

### CROSS-REFERENCE TO RELATED APPLICATIONS

This application claims benefit to U.S. Patent Application No. 61/950,100 filed on 2014-03-08.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Disclosed herein is an educational life skills board game and electronic version thereof. None of the known inventions and patents, taken either singularly or in combination, is seen to describe the instant disclosure as claimed.

### BRIEF SUMMARY OF THE INVENTION

A learning game played by a one or more players comprising a game board, a one or more avatars, a random number generators, a currency, an items table having a plurality of items. Each of said plurality of items having a description, a one or more prices, and a need or want flag. Said need or want flag of said plurality of items comprise a categorization into a needs category and a wants category. Said game board having a plurality of spaces. Said plurality of spaces comprising at least a one or more payment spaces, a one or more bad event spaces, and a one or more savings spaces. Said one or more players are each assigned one among said one or more avatars, a copy of said items table. Said one or more players take turns engaging said random number generators, circulating said game board, reacting to said plurality of spaces, spending and collecting said currency, and collecting a portion of said plurality of items. A winner among said one or more players is designated when a first among said one or more players completes a portion of said plurality of items characterized into said needs category with said need or want flag.

### BRIEF DESCRIPTION OF THE SEVERAL VIEWS OF THE DRAWING

FIG. 1 illustrates an elevated overview of a learning game.

FIG. 2 illustrates a detailed elevated overview of a portion of said game board.

FIG. 3 illustrates an elevated overview of said currency.

FIGS. 4A and 4B illustrate an elevated front view and an elevated rear view of a first key card.

FIGS. 4C and 4D illustrate an elevated front view and an elevated rear view of a second key card.

FIGS. 5A and 5B illustrate an items table, broken between two pages and figures.

FIG. 5C illustrates a key cards table.

FIG. 5D illustrates a board spaces table.

FIGS. 6A, 6B, 6C, 6D and 6E illustrate a player table, a games played table, a turns itemized table, a player acquisitions table, and an exemplary game board.

FIG. 6D illustrates said player acquisitions table.

FIG. 6E illustrates said exemplary game board.

FIG. 7 illustrate a DB relationship graphic for said learning game.

FIG. 8 illustrate a player checklist.

FIGS. 9A, 9B and 9C illustrate an elevated front view of a computer, a block diagram of an address space, and a block diagram of a data storage.

### DETAILED DESCRIPTION OF THE INVENTION

Described herein is an educational life skills board game and electronic version thereof. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

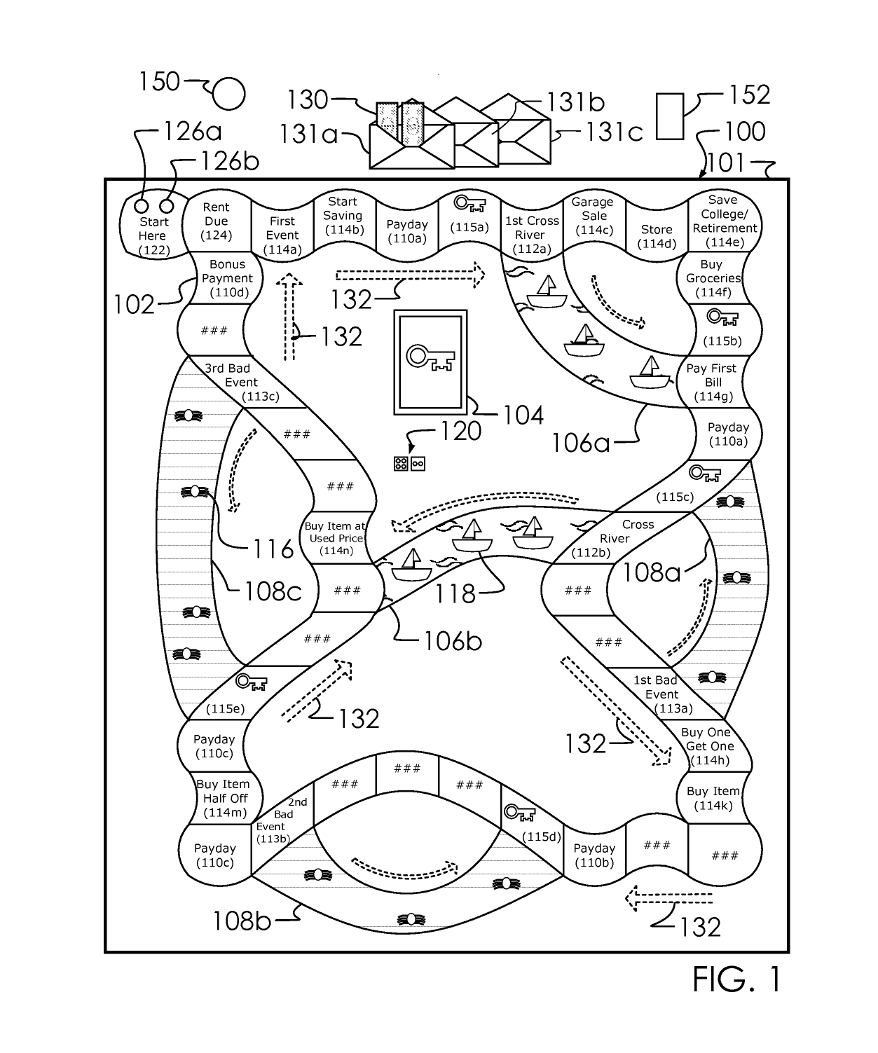

FIG. 1 illustrates an elevated overview of a learning game 100.

The goals of this learning game 100 are to learn how to be responsible with money; furnish an apartment; pay bills on time; participate in group activities; and enjoy independence. A player can win when they furnish their apartment (buy all the ‘needs’ items from an item checklist 152), everyone else goes broke, or be the person who has the most ‘need items’ purchased when you decide to stop playing the game.

In one embodiment, said game board 100 can comprise a game board 101 having a plurality of spaces 102 arranged in a circuitous path, a plurality of key cards 104, a one or more shortcuts (such as a first shortcut 106a and a second shortcut 106b), and a one or more regression paths (such as a first regression path 108a, a second regression path 108b and a third regression path 108c). In one embodiment, said plurality of spaces 102 can comprise a one or more payment spaces (such as a first payday 110a, a second payday 110b, a third payday 110c and a bonus payment 110d), a one or more shortcut spaces associated with said one or more shortcuts (such as a first cross river space 112a for said first shortcut 106a and a second cross river space 112b for said second shortcut 106b), a one or more bad event spaces associated with said one or more regression paths (such as a first bad event 113a for said first regression path 108a, a second bad event 113b for said second regression path 108b, and a third bad event 113c for said third regression path 108c), a plurality of event spaces (such as a first event space 114a, a start saving space 114b, a garage sale space 114c, a store space 114d, a save for college or retirement space 114e, a buy groceries space 114f, a pay first bill space 114g, a buy one get one space 114h, a buy item space 114k, a buy item half off space 114m and a buy item at used price space 114n), a one or more select key card spaces (such as a first key card space 115a, a second key card space 115b, a third key card space 115c, a fourth key card space 115d, and a fifth key card space 115e), a start here space 122, and a rent due space 124. In one embodiment, said one or more shortcuts can have graphical icons of a one or more sailboats 118; and said one or more regression paths can comprise graphical icons of a one or more spiders 116. In one embodiment, said learning game 100 can be paid with a one or more random number generators (such as a pair of dice 120). In one embodiment, said learning game 100 can be played with a one or more avatars (such as a first avatar 126a and a second avatar 126b). In one embodiment, a portion of said plurality of spaces 102 can be illustrated with a “###” in place rather than a detailed game instruction, such spaces are placeholders and indicated that they can be any among the plurality of spaces 102 discussed in detail elsewhere in this disclosure. Of course, gameplay can be modified according to a placement scheme among said plurality of spaces 102, as is known in the art.

In one embodiment, said learning game 100 can comprise said game board 101, a currency 130 (which can comprise of paper notes in a plurality of denominations, as is known in the art), a plurality of envelopes, and a one or more garage sale tokens 150. Said currency 130 can be tracked by an electronic account managed by a computer, as discussed below. In one embodiment, each of the players of said learning game 100 can be issued one of said one or more avatars, a portion of said currency 130, and a portion of said plurality of envelopes. In one embodiment, said plurality of envelopes can comprise a one or more sets of an emergency savings 131a, a college and retirement savings 131b, and a vacation savings 131c.

Said currency 130 placed in said plurality of envelopes can be used to pay bills, but not to purchase items from said item checklist 152. This can teach players that savings are for higher importance expenses than the purchase of items such as furnature.

In one embodiment, said learning game 100 is played in a default direction of play 132. In one embodiment, said default direction of play 132 can be described as generally clockwise. In one embodiment, said plurality of spaces 102 are arranged in a loop with said start here space 122 at a tangential point about an exterior point on said plurality of spaces 102. In one embodiment, said default direction of play 132 can be broken by landing on said one or more shortcut spaces or said one or more bad event spaces, which will cause a player to cross said one or more shortcuts or said one or more regression paths, respectively.

In one embodiment, landing on one of said one or more shortcut spaces can compel a user to take a shortcut around a portion of said plurality of spaces 102. For example, in one embodiment, landing on said first cross river space 112a can compel a user to skip five spaces forward and to land on said third event space 114c. Accordingly, landing on said one or more shortcut spaces can provide an advantage to users in arriving at said one or more payment spaces more quickly and for circulating around said game board 101 in fewer turns. In one embodiment, said one or more sailboats 118 on said one or more shortcuts can be useful in teaching the players that shortcuts are fun, like sailing past obstacles.

Likewise, in one embodiment, landing on one of said one or more bad event spaces can compel a player of said learning game 100 to move backward across said one or more regression paths. For example, in one embodiment, a player landing on said first bad event 113a forces a player to move his avatar back across said first regression path 108a, as illustrated. Accordingly, landing on one of said one or more bad event spaces can cost a player time and resources and therefore be disadvantageous. In one embodiment, said one or more spiders 116 on said one or more regression paths can serve to frighten players of said learning game 100.

In one embodiment, said one or more select key card spaces can compel a player of said learning game 100 to select one among said plurality of key cards 104. Said plurality of key cards 104 are discussed further below.

Said one or more payment spaces trigger a payment of said currency 130 to players as they pass or land on said one or more payment spaces. Accordingly, advancement around said plurality of spaces 102 is encouraged.

In one embodiment, said one or more players are each assigned said one or more garage sale tokens 150. In one embodiment, said one or more garage sale tokens 150 entitles a player to sell one or more items from said item checklist 152, as described below. In one embodiment, said one or more players may select to purchase said plurality of items at either a retail price or a used price, and they can select to sell items they own at said used price. In one embodiment, said players can only sell items while using said one or more garage sale tokens 150. In one embodiment, each player is assigned one of said one or more garage sale tokens 150.

In one embodiment, merely passing (rather than actually landing on) some spaces obligates a player to enact the requirements of that space. For example, in one embodiment, where a user passes over said rent due space 124, they are required to pay rent even if said pair of dice 120 do not put that player on said rent due space 124. Likewise, savings spaces (such as said start saving space 114b) and payday spaces (such as said first payday 110a) operate in this manner.

In one embodiment, said plurality of spaces 102 can comprise a one or more buy spaces (such as said buy one get one space 114h, said buy item space 114k, said buy item half off space 114m, said buy item at used price space 114n and said buy groceries space 114f). In one embodiment, a player is not required to purchase an item from said item checklist 152 when landing on one among said one or more buy spaces, but he or she may have the opportunity to do so. One or more among said one or more buy spaces can comprise special discounts; e.g., said buy one get one space 114h can allow a player to purchase two items for the price of one and said buy item half off space 114m can allow said player to buy something at half price. These spaces allow the learning game 100 to teach the benefit of timing and planning when acquiring goods. However, when an item is acquired, it must be checked off the list in said item checklist 152.

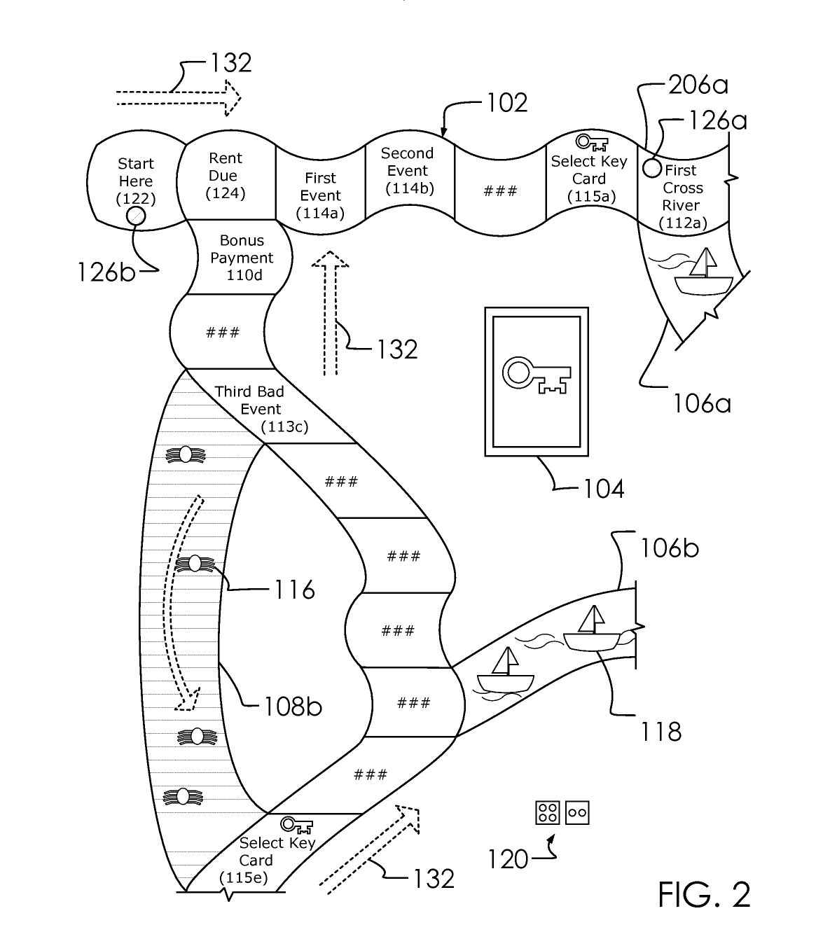

FIG. 2 illustrates a detailed elevated overview of a portion of said game board 101. In one embodiment, said start here space 122 can comprise a starting point for said learning game 100. Game play can progress by alternating among players according to conventional board game rules: rolling said pair of dice 120, moving said one or more avatars around said plurality of spaces 102, landing on a player location among said plurality of spaces 102, and reacting to an instruction found at said player location. For example, in one embodiment, a first player can roll said pair of dice 120, move said first avatar 126a six spaces forward according to the sum of the numbers found on said pair of dice 120, land on a first player location 206a, and implement said instruction from said first player location 206a which is to “cross river” (first cross river space 112a), causing said first avatar 126a to move to said third event space 114c (not illustrated here).

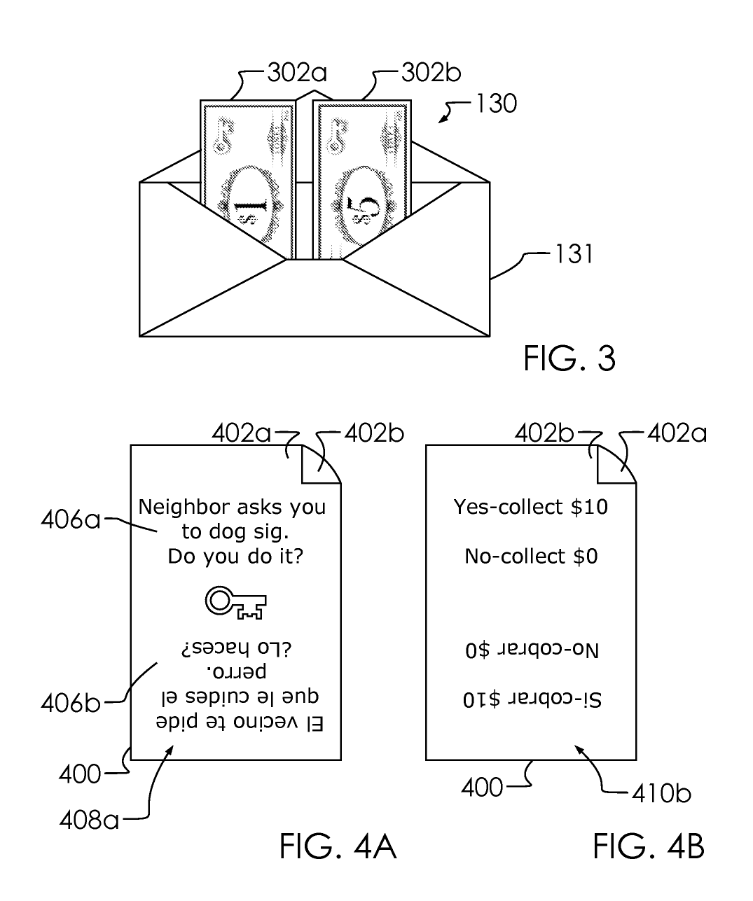

FIG. 3 illustrates an elevated overview of said currency 130. As discussed, said currency 130 can be issued in said plurality of denominations. For example, in one embodiment, said plurality of denominations can comprise a first denomination 302a (comprising a one credit/dollar bill) and a second denomination 302b (comprising a five credit/dollar bill).

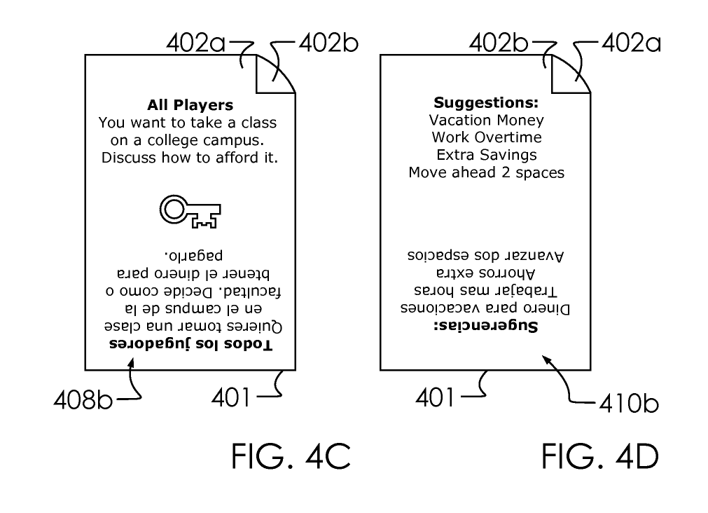

FIGS. 4A and 4B illustrate an elevated front view and rear view of a first key card 400. In one embodiment, said first key card 400 can comprise a first side 402a and a second side 402b. In one embodiment, text on said first key card 400 (and all among said plurality of key cards 104) can comprise a plurality of language translations, such as a first language translation 406a and a second language translation 406b; where said first language translation 406a is English and said second language translation 406b is Spanish. In one embodiment, said plurality of language translations can comprise two or more languages and need not be restricted to just English and Spanish. In fact, in a preferred embodiment, Chinese, Filipino, and other selected languages can be added as necessary for teaching players life skills. In one embodiment, said first side 402a can comprise a question for a player and said second side 402b can comprise a resulting action to occur to said player.

One objective of said plurality of key cards 104 is to ask the players a first life choice question 408a on said first side 402a which may occur in the course of normal life events, so that the player is given a chance to consider the ramifications of good life choices. A first life choice consequences message 410a can be printed on said second side 402b. For example, in one embodiment, a player is asked if they would like to dog sit for a neighbor (see FIG. 4A), and if the player decides to do so he will be rewarded with $10 of said currency 130.

In one embodiment, said plurality of key cards 104 can comprise several different types of key cards, where many are similar to said first key card 400 which poses a question and outcome to an individual, but others pose a question to all players of said learning game 100.

FIGS. 4C and 4D illustrate an elevated front view and an elevated rear view of a second key card 401. Here, said second key card 401 is useful for creating discussion among all the players of said learning game 100, by posing a question to all player. Unlike said first key card 400, said second key card 401 has more than a yes or no answer and will require players to exercise analytical skills while considering the dilemma. Also, rather than a cash reward, players are rewarded by advancing around said plurality of spaces 102. Thus, in one embodiment said second key card 401 can comprise a second life choice question 408b and a second life choice consequences message 410b addressed to all players of said learning game 100.

Accordingly, said plurality of key cards 104 can address one or more or, in some circumstances, all of the players of said learning game 100.

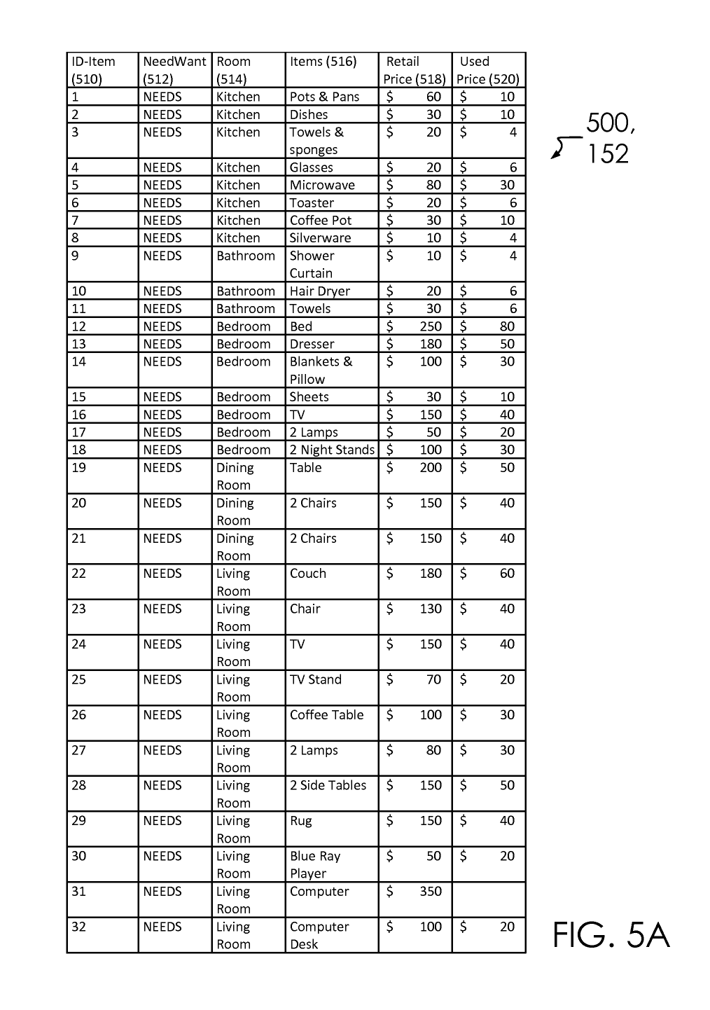

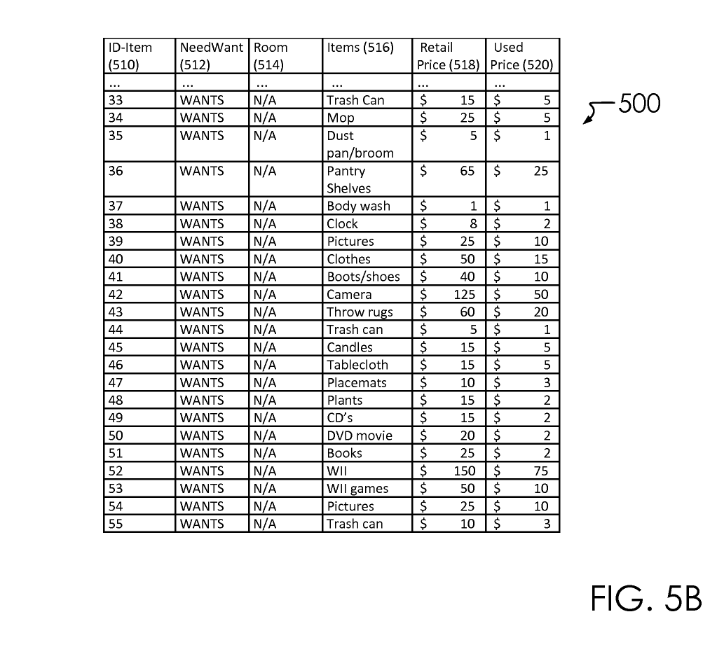

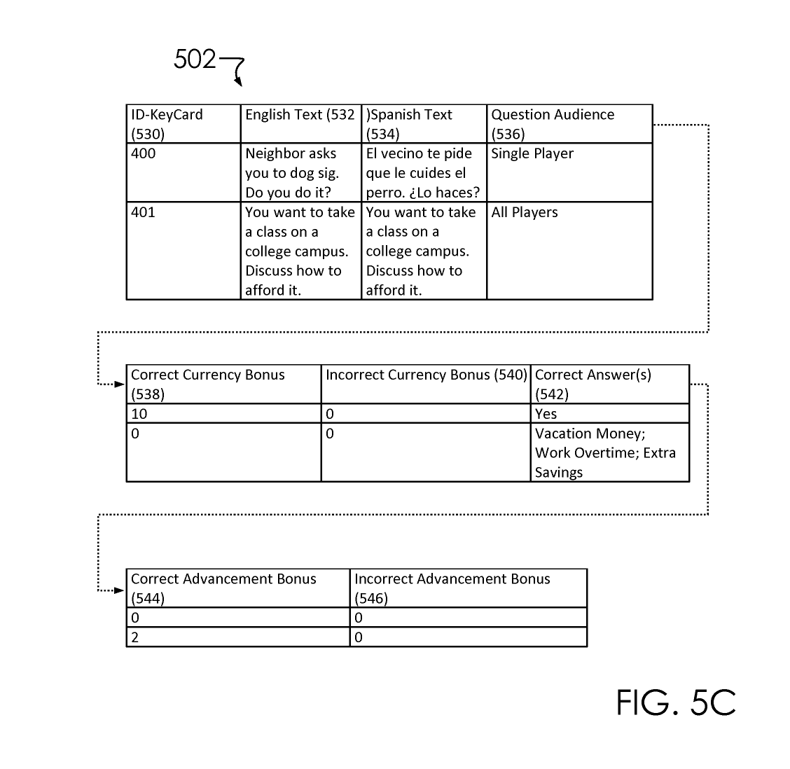

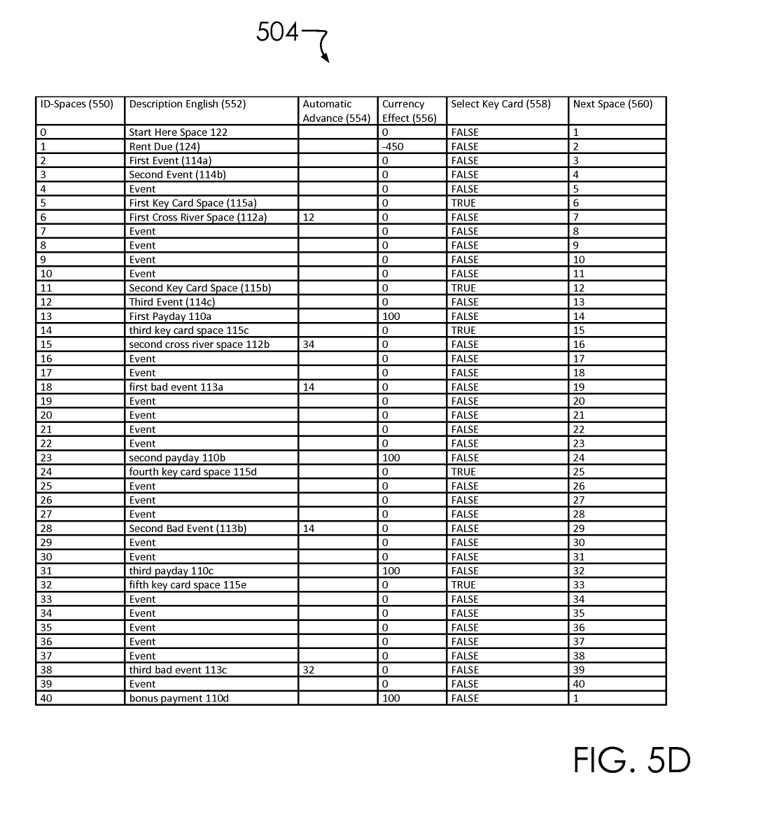

FIGS. 5A and 5B illustrate an items table 500, broken between two pages and figures.

Said items table 500 can comprise a plurality of columns of data for tracking a list of items for sale to players of said learning game 100. Here, said items table 500 is illustrated as a database table, but said learning game 100 is also illustrated as a physical board game; wherein, said items table 500 can comprise a checklist of items with similar characteristics as illustrated and described. Said items table 500 is also described as said item checklist 152, above.

In one embodiment, said items table 500 can comprise the following fields: an id-item 510, a needwant 512, a room 514, an items 516, a retail price 518, and a used price 520. In one embodiment, said id-item 510 can comprise a unique identifier field, as is known in the art. In one embodiment, each entry into said items table 500 can be categorized as either a “need” or a “want”, where players of said learning game 100 must decide to either purchase something they need or something they want according to the categorization. Thus, said learning game 100 can be useful in teaching its players to prioritize the purchase of items according to significance. In one embodiment, said room 514 can further categorize the items in said items table 500 according to their domestic use. Said items 516 can comprise a description of the items for each among said the rows of said items table 500. In one embodiment, each among said items 516 can comprise said retail price 518 (being a purchase price at retail) or a used price 520 (being a purchase price at a used location such as a garage sale or a thrift store or similar). In one embodiment, said learning game 100 can be useful in teaching players the value of shopping for a lower price and of purchasing used goods rather than new ones.

Said items table 500 can be used as list of items for sale to players, and represent an objective of the game. For example, in one embodiment, each player can be required to purchase each among said items table 500 where said needwant 512 is set to “NEED”.

Accordingly, said plurality of items can comprise a need or want flag (in said needwant 512), a use location (in said room 514), a description (in sad items 516), said retail price 518 and said used price 520.

In one embodiment, once a player has acquired an item among said items table 500, he may later resale that item at said used price 520 to cover expenses during game play of said learning game 100. Thus, in one embodiment said learning game 100 can teach players that items depreciate between the time of purchase and the time of sale and that goods can be made to be liquid to cover expenses.

Note that said needwant 512 is set to “needs” in FIG. 5A and set to “wants” on FIG. 5B.

FIG. 5C illustrates a key cards table 502.

In one embodiment, said key cards table 502 can comprise a database representation of said plurality of key cards 104; where said plurality of key cards 104 are used for a physical board game and said key cards table 502 is used for an electronic version of said learning game 100.

In one embodiment, said key cards table 502 can comprise an id-keycard 530, an English text 532, a Spanish text 534, a question audience 536, correct currency bonus 538, incorrect currency bonus 540, correct answer(s) 542, correct advancement bonus 544, and an incorrect advancement bonus 546. In one embodiment, said id-keycard 530 can comprise a unique identifier associated with each row of said key cards table 502. In one embodiment, said English text 532 and said Spanish text 534 can represent an English translation and a Spanish translation for said id-keycard 530, respectively. In one embodiment, said question audience 536 can comprise define which among said players of said learning game 100 are supposed to answer a question. Said correct answer(s) 542 can comprise a correct answer or list of correct answers for a question posed by said id-keycard 530.

In one embodiment, said plurality of key cards 104 can comprise a reward or penalty associated with a correct or incorrect answer; for example, said correct currency bonus 538 and said correct advancement bonus 544 can comprise a credit toward said currency 130 or said plurality of spaces 102 for the player if answered correctly, and said incorrect currency bonus 540 and incorrect advancement bonus 546 can comprise a penalty for an incorrect answer.

FIG. 5D illustrates a board spaces table 504.

In one embodiment, said board spaces table 504 can comprise a listing of said plurality of spaces 102 with additional metadata for keeping gameplay organized in a software context.

Said board spaces table 504 can comprise an id-spaces 550, a description English 552, an automatic advance 554, a currency effect 556, a select key card 558 and a next space 560. In one embodiment, said id-spaces 550 can comprise a unique identifier for each row in said board spaces table 504. In one embodiment, said description English 552 can comprise an English description of each space among said plurality of spaces 102; in another embodiment a one or more additional fields can be provided to present a translation of each among said description English 552. In one embodiment, said automatic advance 554 can comprise a cross reference to another among said rows of said board spaces table 504 as identified by said id-spaces 550; wherein, if a player lands on one among said board spaces table 504 with a value in said automatic advance 554, then it is programmatically implemented that that player's avatar shall automatically advance to said plurality of spaces 102 identified by said automatic advance 554. In one embodiment, said currency effect 556 can comprise a credit or debit to be attributed to said player when landing on a space. In one embodiment, said select key card 558 can comprise a binary field comprising of a “True” or “False” answer related to whether a key card shall be selected when a user lands on a particular space; wherein, if said select key card 558 is set to “true” one among said plurality of key cards 104 shall be selected and implemented. In one embodiment, said next space 560 can a listing of a next space on said plurality of spaces 102 which follows a current space; wherein, if a player passes a space but does not land on it, said next space 560 designates which space is to follow the current space. Note that said next space 560 is “1” after the last row in said board spaces table 504; accordingly, said board spaces table 504 represents a circular list which restarts after it is completed.

In one embodiment, where a player passes said one or more payment spaces (such as payday or bonus spaces) or rent due space 124, said currency effect 556 shall be added or debited to that user's account.

The fields in said board spaces table 504 are exemplary and do not represent a preferred list of spaces; but due to special constraints, many of the rows merely list “Event” in said description English 552 and have no ramification when landed on. In a preferred embodiment, many life lessons can be taught to players of said learning game 100 through the writing and descriptions associated with said description English 552 in said board spaces table 504; as well as those among said English text 532 of said key cards table 502.

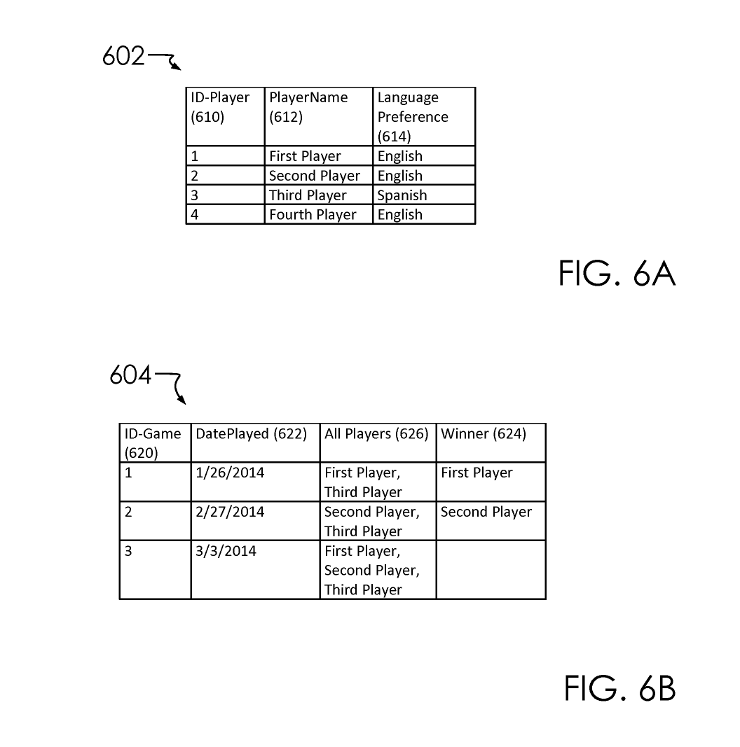

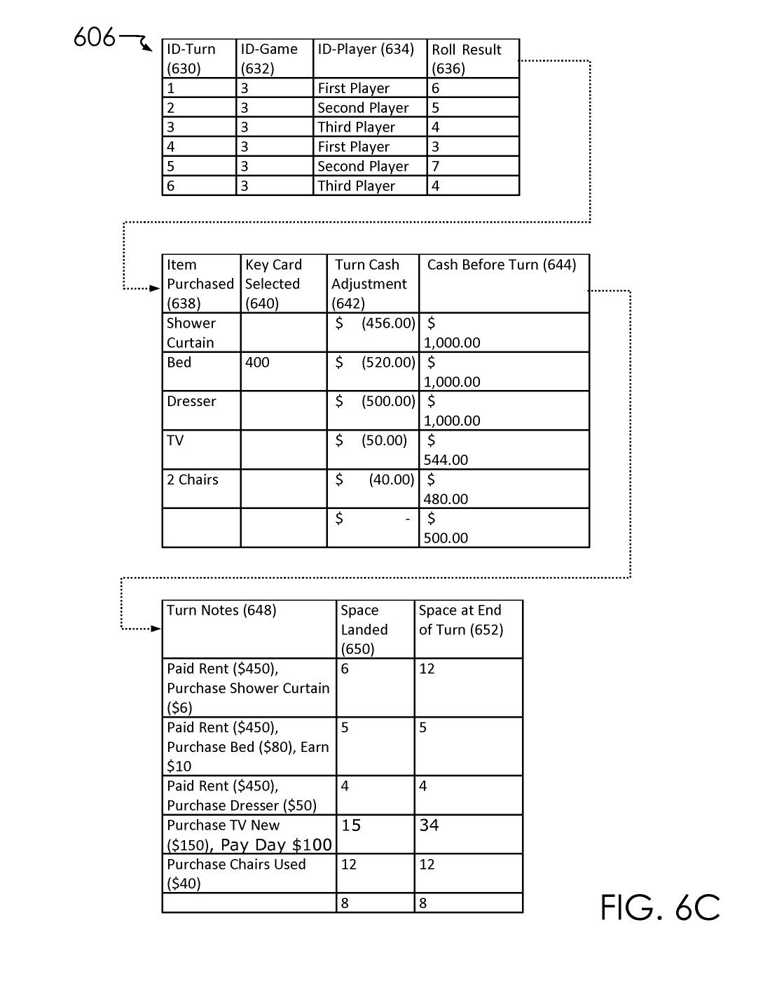

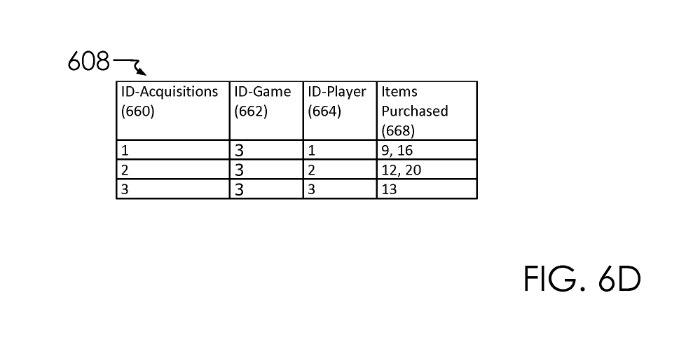

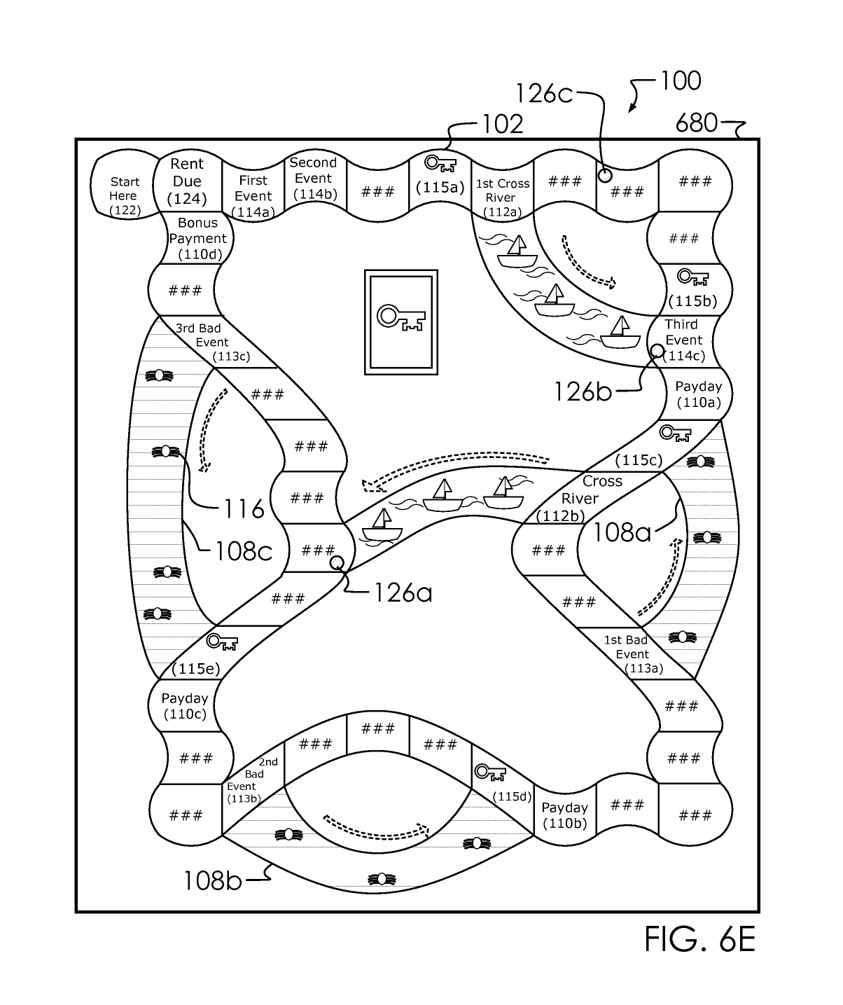

FIGS. 6A, 6B, 6C, 6D and 6E illustrate a player table 602, a games played table 604, a turns itemized table 606, a player acquisitions table 608, and an exemplary game board 680.

Now that the basic lists of items, spaces and key cards have been established—in said items table 500, said key cards table 502, and said board spaces table 504—a few tables must be established for tracking game play, these include said player table 602, said games played table 604, said turns itemized table 606 and said player acquisitions table 608.

Said player table 602 (corresponding to FIG. 6A) can comprise a list of players who have or are playing said learning game 100. In one embodiment, said player table 602 can comprise an id-player 610 (comprising a unique identifier for the rows in said player table 602), a playername 612 (comprising a name of each player), and a language preference 614 (comprising a language preferred by each player). In one embodiment, said learning game 100, in a software embodiment, can present a translation of the gameplay dialogs to players according to said language preference 614.

Said games played table 604 (corresponding to FIG. 6B) can comprise a table of games having been played previously. In one embodiment, said games played table 604 can comprise an id-game 620 (comprising a unique identifier each game having been or currently being played), a dateplayed 622 (comprising a date which it was played), an all players 626 (listing all the players involved in a particular game), and a winner 624 (identifying a winner of each game played). In one embodiment, said dateplayed 622 can comprise a date stamp (shown) and time stamp (not shown).

Said turns itemized table 606 (corresponding to FIG. 6C) can comprise a list wherein each row represents a turn having been performed by one of the players of said learning game 100. Said turns itemized table 606 can comprise fields comprising: an id-turn 630 (comprising a unique identifier for each turn having been played), an id-game 632 (referring to said id-game 620 of said games played table 604), an id-player 634 (referring to said id-player 610 of said player table 602), a roll result 636 (which can comprise a random number between a minimum and a maximum threshold, which can comprise 2-12 in the case of two six-sided dice), an item purchased 638 (comprising a reference to said id-item 510 of said items table 500, which represents one item purchased by a user on a turn), a key card selected 640 (comprising a reference to said id-keycard 530 of said key cards table 502, which represents one of said plurality of key cards 104 which is to be enacted on a turn), a turn cash adjustment 642 (which can be a calculation of amounts received less amounts spent on a turn), a cash before turn 644 (which can comprise a calculation of resources available to a player before a turn begins), a turn notes 648 (which can comprise a text field storing notes about a turn), a space landed 650 (which can comprise a calculation of a space landed on by a player during a turn, which can comprise adding said rollresult 636 to a previous location), and a space at end of turn 652 (which can comprise a calculation of the location of a player at the end of his turn).

In one embodiment, players can begin the game with an initial amount of currency 130 (such as $1000, as illustrated), and their initial location among said plurality of spaces 102 can comprise said id-spaces 550 equal to “0” (that is, said start here space 122).

Accordingly, a review of the six rows in said turns itemized table 606 (corresponding to FIG. 6C) reveals that the first player rolled a “6”, passed said rent due space 124, landed on said first cross river space 112a, which automatically advanced him to said third event space 114c, where his advancement ended. He thereafter purchased a shower curtain (corresponding to part “9” of said id-item 510 in said items table 500. His turn thereafter ended. This turn cost him the price of rent ($450) and the price of the shower curtain at a used price ($6). After his two competitors had their turns, he rolled a 3, passed said first payday 110a, landed on said second key card space 115b, automatically advanced to said space “34” (of said id-spaces 550), purchased a “TV” from said items table 500, and ended his turn.

Reviewing said turns itemized table 606 can demonstrate the method for tracking the game play with a software program. It includes only two turns be each of three players, however it is exemplary of how said learning game 100 can be played.

FIG. 6D illustrates said player acquisitions table 608.

In one embodiment, said player acquisitions table 608 can comprise a table for tracking the acquisitions of each of the players in a game. In one embodiment, said player acquisitions table 608 can comprise: an id-acquisitions 660 (which can comprise a unique identifier of each player and game played so as to track purchases), an id-game 662 (related to said id-game 620 of said games played table 604), an id-player 664 (which can comprise a reference to said id-player 610 of said player table 602) and an items purchased 668 (which can comprise a list of one or more items from said items table 500 as identified by said id-item 510).

In one embodiment, said player acquisitions table 608 can comprise a summary of activities occurring in said turns itemized table 606. Thus, in one embodiment said player acquisitions table 608 can be updated through a game; as here in said id-game 662 equal to “3”.

FIG. 6E illustrates said exemplary game board 680.

In one embodiment, said exemplary game board 680 can demonstrate a status of said learning game 100 after each of the turns in said turns itemized table 606 have been implemented. Note the locations of said one or more avatars (which can comprise said first avatar 126a, said second avatar 126b, and a third avatar 126c).

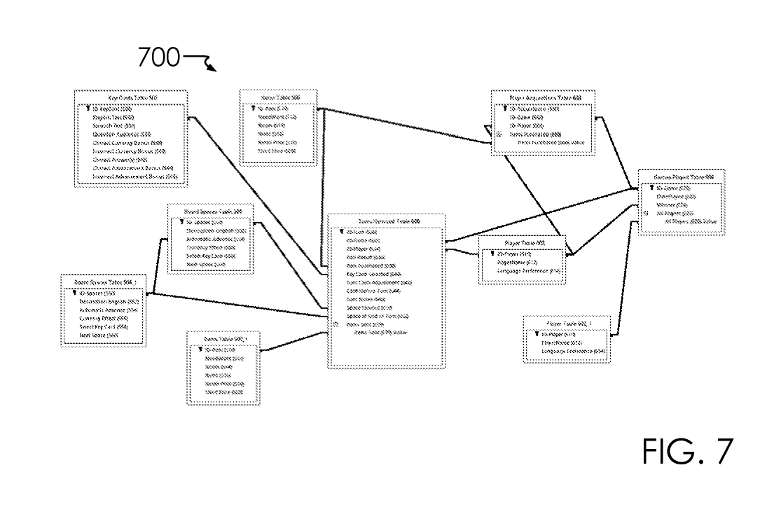

FIG. 7 illustrate a DB relationship graphic 700 for said learning game 100.

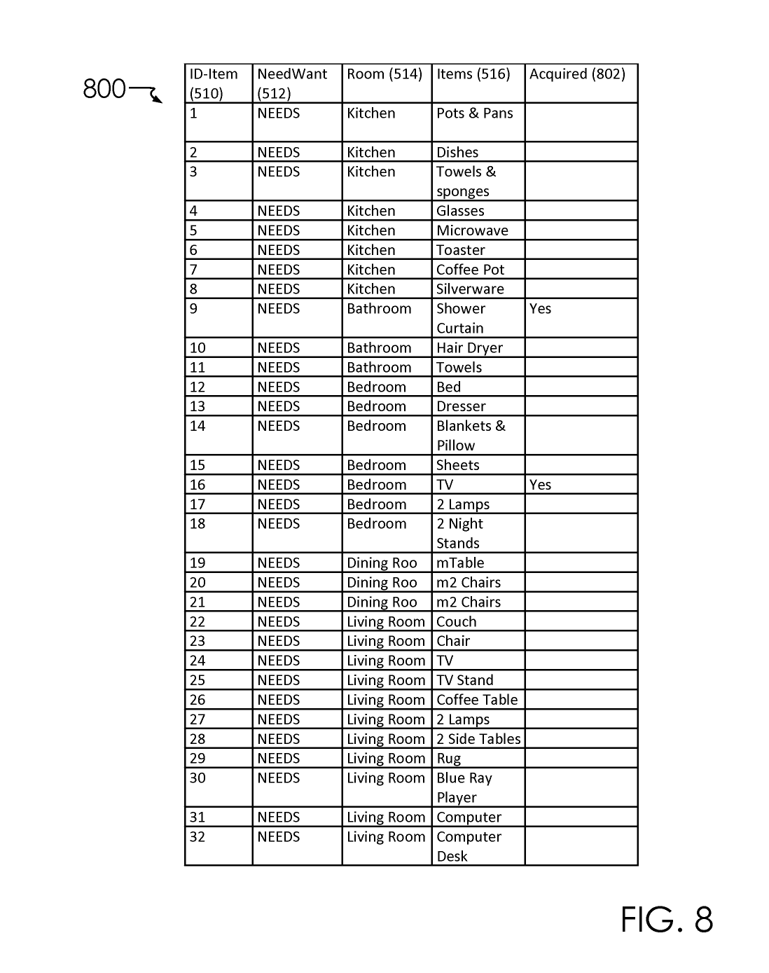

FIG. 8 illustrate a player checklist 800.

In one embodiment, said player checklist 800 can comprise a list of items from said needwant 512 marked “needs” with an acquired 802 field for tracking whether a player has acquired an item. In one embodiment, said player checklist 800 can comprise said id-item 510, said needwant 512, said room 514, said items 516 and said acquired 802, as illustrated.

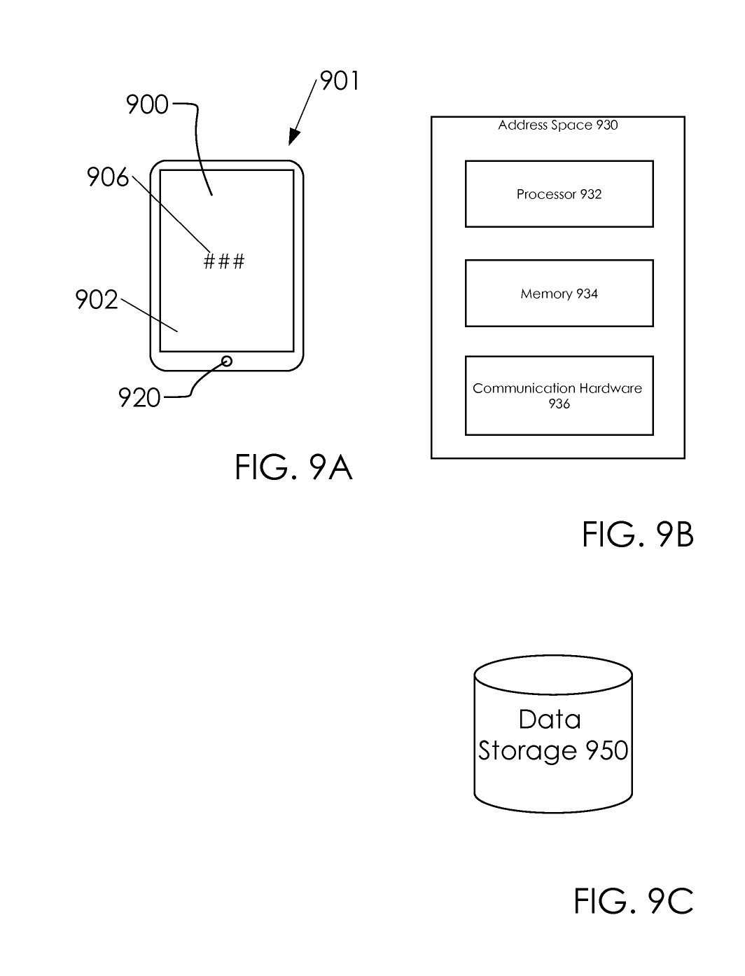

FIGS. 9A, 9B and 9C illustrate an elevated front view of a computer 901, a block diagram of an address space 930, and a block diagram of a data storage 950.

In one embodiment, said computer 901 can comprise a screen 902, a user interface equipment (such as a button 920) and a displayed data 906. In one embodiment, said address space 930 can comprise a processor 932, a memory 934, and a communication hardware 936. In one embodiment, said data storage 950 can comprise a database stored on a server or on said computer 901.

In one embodiment, said learning game 100 can comprise a computer learning game 900 which can be displayed as said displayed data 906 on said screen 902 of said computer 901. In one embodiment, said computer 901 can comprise a tablet, a PC, a Mac (R), a smartphone, or similar. In one embodiment, said computer 901 can comprise said address space 930. In one embodiment, said computer learning game 900 can be stored in said memory 934 and processed in said processor 932. In one embodiment, said computer learning game 900 can be communicated as between said one or more players on more than one of said computer 901 through said communication hardware 936 (which can comprise a Bluetooth, Wi-Fi, or similar). In one embodiment, aid DB relationship graphic 700 can be encapsulated in said data storage 950. In one embodiment, said data storage 950 can be stored on said computer 901 or on a server, as is known in the art.

In one embodiment, said computer learning game 900 can be played on a one or more computers each being similar to said computer 901, as described and understood in the art.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A learning game played by a one or more players comprising:
a game board, a one or more avatars, a random number generators, a currency, an items table having a plurality of items;
each said plurality of items having a description, a one or more prices, and a need or want flag;
said need or want flag of said plurality of items comprise a categorization into a needs category and a wants category;
said game board having a plurality of spaces;
said plurality of spaces comprising at least a one or more payment spaces, a one or more bad event spaces, and a one or more savings spaces;
said one or more players are each assigned one among said one or more avatars, a copy of said items table;
said one or more players take turns engaging said random number generators, circulating said game board, reacting to said plurality of spaces, spending and collecting said currency, and collecting a portion of said plurality of items; and
a winner among said one or more players is designated when a first among said one or more players completes a portion of said plurality of items characterized into said needs category with said need or want flag.

2. Said learning game of claim 1 further comprising a plurality of envelopes assigned to each among said one or more players; wherein,
said plurality of envelopes comprise an emergency savings, a college and retirement savings, and a vacation savings; and
said one or more players use said plurality of envelopes as savings accounts for future expenses.

3. Said learning game of claim 1 further comprising a plurality of key cards; wherein,
when one among said one or more players of said learning game lands on said one or more select key card spaces they must select one among said plurality of key cards and follow its instructions;
said plurality of key cards comprise questions and answers posed to said one or more players; and
a correct response to said questions results in a positive consequence and/or a negative consequence for a currency or a position of said one or more avatars of said players on said plurality of spaces.

4. Said learning game of claim 3 wherein:
one or more among said plurality of key cards comprise a question for one among said one or more players.

5. Said learning game of claim 3 wherein:
one or more among said plurality of key cards comprise a question for all among said one or more players.

6. Said learning game of claim 1 wherein each said plurality of items further comprise a characterization into a use location.

7. Said learning game of claim 1 wherein said one or more prices of said plurality of items comprise:
a retail price and a used price;
said one or more players of said learning game may select to purchase said plurality of items at either of said one or more prices; and
said one or more players of said learning game may select to sell items they own at said used price.

8. Said learning game of claim 7 wherein said plurality of spaces comprise a buy item at used price space; further wherein,
said used prices are available when said one or more players land on said buy item at used price space.

9. Said learning game of claim 7 further comprising a one or more garage sale tokens assigned to each among said one or more players; wherein,
each among said one or more players may use said one or more garage sale tokens in order to sell one or more among said plurality of items at said used price.

10. Said learning game of claim 7 wherein said retail price is based on market prices for new items and said used price is typically lower than said retail price.

11. Said learning game of claim 1 wherein:
said plurality of spaces are arranged in a looping configuration.

12. Said learning game of claim 1 wherein:
said one or more payment spaces comprise credit actions including payday spaces, investment income spaces, bonus payment spaces

13. Said learning game of claim 1 wherein:
said one or more bad event spaces comprise a rent due space, and a buy groceries space.

14. Said learning game of claim 1 wherein:
said one or more savings spaces comprise a start saving space, and a save for college or retirement space.

15. Said learning game of claim 1 further comprising a one or more shortcuts arranged on said game board; wherein,
a player of said learning game landing on said one or more shortcut spaces skips forward around said plurality of spaces.

16. Said learning game of claim 15 wherein said one or more shortcut spaces skip past one or more of said one or more bad event spaces.

17. Said learning game of claim 1 further comprising a one or more regression paths arranged on said game board; wherein,
a player of said learning game landing on said one or more regression paths skips backward on around said plurality of spaces.

18. A learning game played by a one or more players comprising:
a game board, a one or more avatars, a random number generators, a currency, an items table having a plurality of items;
each said plurality of items having a description, a one or more prices, and a need or want flag;
said need or want flag of said plurality of items comprise a categorization into a needs category and a wants category;
said game board having a plurality of spaces;
said plurality of spaces comprising at least a one or more payment spaces, a one or more bad event spaces, and a one or more savings spaces;
said one or more players are each assigned one among said one or more avatars, a copy of said items table;
said one or more players take turns engaging said random number generators, circulating said game board, reacting to said plurality of spaces, spending and collecting said currency, and collecting a portion of said plurality of items;
a winner among said one or more players is designated when a first among said one or more players completes a portion of said plurality of items characterized into said needs category with said need or want flag;
a plurality of key cards; wherein,
when one among said one or more players of said learning game lands on said one or more select key card spaces they must select one among said plurality of key cards and follow its instructions,
said plurality of key cards comprise questions and answers posed to said one or more players, and
a correct response to said questions results in a positive consequence and/or a negative consequence for a currency or a position of said one or more avatars of said players on said plurality of spaces; and
said one or more prices of said plurality of items comprise:
a retail price and a used price,
said one or more players of said learning game may select to purchase said plurality of items at either of said one or more prices, and
said one or more players of said learning game may select to sell items they own at said used price.

19. A computer learning game played by a one or more players on a one or more computers comprising:
said one or more computers each comprising an address space, a processor, a screen and a memory;
said computer learning game rendered on said screen and stored in said memory;
said computer learning game rendering a game board, a one or more avatars, a random number generators, a currency, an items table having a plurality of items;
each said plurality of items having a description, a one or more prices, and a need or want flag;
said need or want flag of said plurality of items comprise a categorization into a needs category and a wants category;
said game board having a plurality of spaces;
said plurality of spaces comprising at least a one or more payment spaces, a one or more bad event spaces, and a one or more savings spaces;
said one or more players are each assigned one among said one or more avatars, a copy of said items table;
said one or more players take turns engaging said random number generators, circulating said game board, reacting to said plurality of spaces, spending and collecting said currency, and collecting a portion of said plurality of items; and
a winner among said one or more players is designated when a first among said one or more players completes a portion of said plurality of items characterized into said needs category with said need or want flag.

20. Said learning game of claim 19 further comprising a plurality of key cards; wherein,
when one among said one or more players of said learning game lands on said one or more select key card spaces they must select one among said plurality of key cards and follow its instructions;
said plurality of key cards comprise questions and answers posed to said one or more players; and
a correct response to said questions results in a positive consequence and/or a negative consequence for a currency or a position of said one or more avatars of said players on said plurality of spaces.
